(19) United States
(12) Patent Application Publication
(10) Pub. No.: US 2025/0345236 A1
(43) Pub. Date: Nov. 13, 2025

(54) Motion Controlled Toy

(71) Applicant: Quintin Kermeen, Concord, CA (US)

(72) Inventor: Quintin Kermeen, Concord, CA (US)

(21) Appl. No.: 19/200,429

(22) Filed: May 6, 2025

Related U.S. Application Data
(60) Provisional application No. 63/646,102, filed on May 13, 2024.

(51) Int. Cl. A61H 23/02; A61H 19/00

(52) U.S. Cl. CPC A61H 23/02; A61H 19/00; A61H 2201/0111; A61H 2201/501; A61H 2201/5035; A61H 2201/5084; A61H 2201/5097

(57) ABSTRACT

A system a processor coupled to at least one motor controller, said motor controller further coupled to a motorized vibrator. The processor is further coupled to a wireless transceiver and to a remote device. The remote device coupled through the wireless transceiver. The remote device includes one or more motion sensors. The processor is connected to memory and the memory includes non-transient, machine-readable instructions directing the processor to perform a method including communicating with the remote device, receiving an input from the remote device, said input indicative of motion from the remote device, and operating the vibrator in response to the input. Pre-determined vibrating protocols may be effectuated in certain embodiments.

### BENEFIT

This application claims the benefit of co-pending provisional application select all filed May 13, 2024, by the same inventor which is included by reference as if fully set forth herein.

### BACKGROUND OF THE INVENTION

Adult devices exist in many forms to provide sexual pleasure to the user thereof. Accordingly, there is a desire for newer, more advanced systems and devices in this market. Conventional designs require the controller to be an app on a smartphone or a button on a dongle. Both require the person controlling the remote toy to be obvious when turning on the toy remotely. Even if the fob/button controller is in one's pocket, the person must have a hand in the pocket to turn on the device and that can be suspicious and limit anyone's ability to be secretive about what is happening.

### SUMMARY OF THE DISCLOSURE

Disclosed herein is a remote-control adult novelty toy where the person that is controlling the device remotely needs to wear the remote-control watch device on their wrist and then move their arm is a specific, yet not obvious motion, to signal the toy to turn on. The toy then turns on and can be triggered to respond back to the controller letting it know, through vibration, that the device has turned on.

There are many different motions that can be interpreted by the controller to turn on the toy remotely. The controller is nondescript and can be worn on the body of the person controlling the device without garnering attention that it is anything other than a ubiquitous fitness watch or smartphone watch. Therefore, the device can be activated and used in settings where they are not normally used without anyone knowing that it is happening. Examples include places like a family reunion, an amusement park, places of worship or any public place.

Additionally, when used by two or more people who are in a group setting, there can be an added sense of intimacy since the people involved are secretly participating in the activity right out in the open, in front of everyone, yet no one else knows that it is happening.

Described herein are systems and methods for a cryptic, motion-controlled system for human, sexual gratification. The system is built for the sexual gratification of one or more people and certain embodiments may consist of three functional parts:
A sexual gratification device that is worn in or on a human;
A motion activated remote control operation;
An application (App) that controls the operation of the remote control and the gratification device.

### BRIEF DESCRIPTION OF DRAWINGS

FIG. 1 shows a function block diagram in accordance with the current disclosure.

FIG. 2 provide more detail of an embodiment.

### LEXICOGRAPHY

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example, and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

### DESCRIPTION OF THE INVENTION

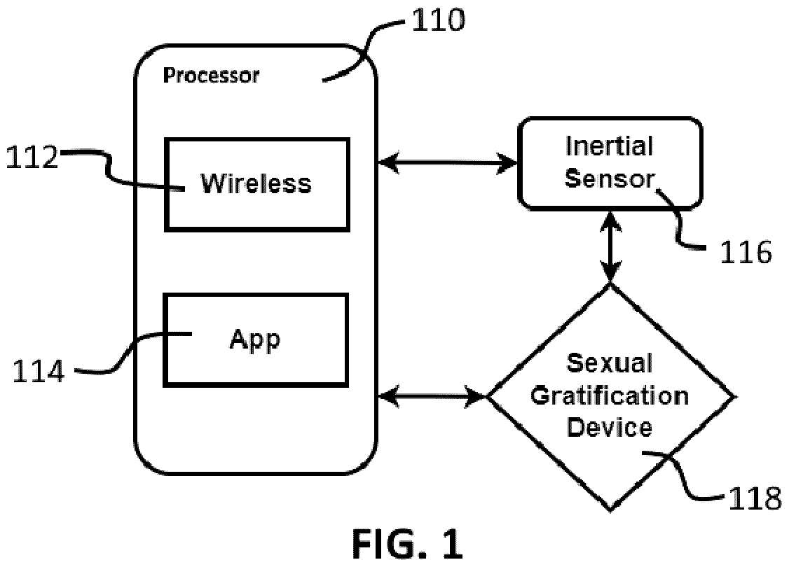

FIG. 1 shows a functional block diagram according to the current disclosure. In FIG. 1 a processing device 110 may include wireless communication 112 technology such as Bluetooth and WIFI. The processing device 110 may include application 114 software coupled to the wireless 112 technology. Also coupled to the processor 110 is an inertial sensor 116. The inertial sensor 116 may be physically disposed with the processor 110 or may be included in separate device (not shown). A sexual gratification device 118 is shown coupled to both the inertial sensor 116 and the processor 110.

### Processor

The methods and techniques described herein may be performed on a processor-based device 110. The processor-based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

The processing system may be a wireless device such as a smart phone, personal digital assistant (PDA), laptop, notebook and tablet computing devices operating through wireless networks. These wireless devices may include a processor, memory coupled to the processor, displays, keypads, Wi-Fi, Bluetooth, GPS and other I/O functionality. Alternatively, the entire processing system may be self-contained on a single device.

Conventionally, client server processing operates by dividing the processing between two devices such as a server and a smart device such as a cell phone or other computing device. The workload is divided between the servers and the clients according to a predetermined specification. For example, in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine-readable instructions may be conventionally known including applets and are written in a variety of languages including Java and JavaScript.

Client-server applications may also provide for software as a service (Saas) applications where the server provides software to the client on an as needed basis. In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus, data to the client device may come from input data from a user, from a memory on the device, from an external memory device coupled to the device, from a radio receiver coupled to the device or from a transducer coupled to the device. The radio may be part of a wireless communications system such as a Wi-Fi or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein, a display engine for user interoperability, a data engine for data storage and processing, an execution engine for method processing, and a user interface (UI) engine and the like may be employed. These engines may seek and gather information about events from remote data sources and provide information to and collect information from users.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effectuate such feature, structure or characteristic in connection with other embodiments whether or not explicitly described. Parts of the description are presented using terminology commonly employed by those of ordinary skill in the art to convey the substance of their work to others of ordinary skill in the art.

### Inertial Sensor

The processing device 110 may function as a remote-control device by coupling to the inertial sensor 116 and the gratification device. The inertial sensor 116 includes sensing devices, including, but not limited to, inertial sensors, accelerometers, and gyroscopes. The inertial sensor 116 may include a controller for performing operations such as recognizing motion patterns (protocols) that may then be used to remotely operate the sexual gratification device 118. These motions can be obvious or clandestine depending upon which motion the user chooses. Differing protocols such as motions, actions, and functions may be used to control the intensity and speed of the gratification device operation.

The controller in the inertial sensors 116 may be a function of the processing device 110 or an independent device such as a wristwatch. Functions of the inertial sensors may be controlled by a software application 114 coupled to or operated by the processing device 110.

### Gratification Device

The sexual gratification device 118 may take many physical forms and perform different environmental functions including, but not limited to, vibrating, pulsating, reciprocating, applying pressure, heat or other functions that may be found sexually gratifying by a human. The gratification device 118 may include a local processor, actuators for the environmental functions, and a transceiver, such as Bluetooth, for communicating to other devices. The gratification device 118 may be battery powered and can be recharged using conventional charging techniques such as wireless charging.

The sexual gratification device 118 may be wirelessly coupled to a controller for operations described herein. The gratification device 118 may include non-volatile memory for storing instructions received from connected devices. These instructions may include directions on how to perform upon reception of certain commands received wirelessly. In some embodiments, the gratification device 118 may present a menu of predetermined actions that may be selected, including, but not limited to, time vibrating, pulsing and vibrating combinations, and the like.

### Motion Activated, Remote Control Device

In some embodiments the motion activated, remote control device's component function within the device are as follows:
a. A wristband holds the housing on the wrist, and a battery powers the circuit board.
b. An input, such as a button may be employed so that a user can toggle through different vibrating patterns and intensities which will, in turn, set the vibrating pattern and intensity of the vibrating toy. The settings are interpreted by the microprocessor and sent by a Bluetooth antenna to the vibrating toy, setting it to use the specified pattern and intensity when activated. The button can also be used to stop the toy after vibration starts.
c. An accelerometer and gyroscope may detect motions that the microprocessor interprets. When specific, preset motions are identified, then a signal is sent from the Bluetooth antenna. This signal can be received by the vibrating novelty toy and the vibration begins, ending either after a specified period or by a button push on the wrist controller.
d. At the recipient's discretion, the vibrating toy can be made to respond, in which case, the vibrator motor in the wrist controller vibrates, indicating that the recipient did in fact receive the vibration.

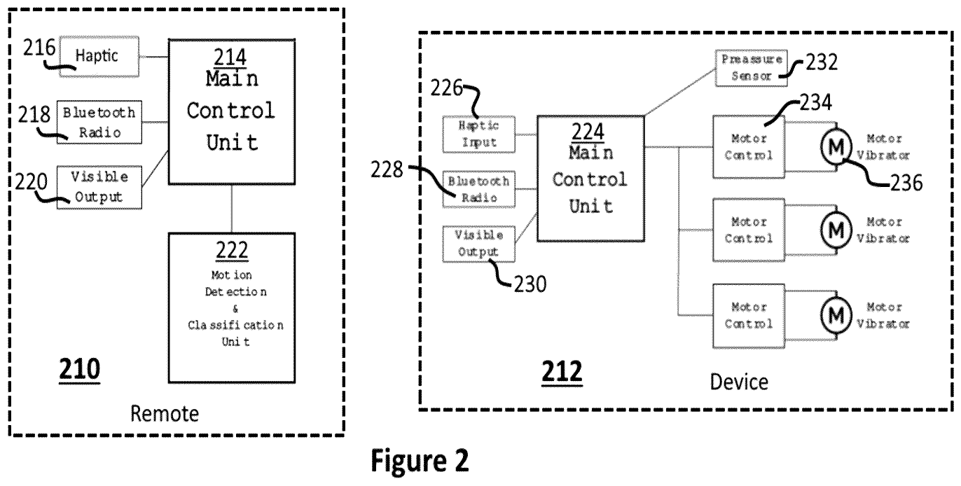

FIG. 2 shows details of one embodiment according to the current disclosure. In FIG. 2 a remote device 210 is coupled to a gratification device 212 using Bluetooth 220 and 228 technology. A main controller 214 is couped to motion sensors 222 such as accelerometers and includes processing instructions to detect motion and operate in response to the detected motion. The remote 210 includes input/output (I/O) devices such as haptic feedback 216, Bluetooth 218, and a visible output 220 such as one or more LEDS, a digital display, and the like. Some embodiments may include buttons (not shown) for user input.

FIG. 2 also shows a block diagram of a gratification device 212. The device 212 includes a controller 224 coupled to a haptic sensor 226, a Bluetooth radio 228, and an optional visual output 230. The controller 224 is also coupled to a pressure sensor 232 and one or more motor controller 234, each coupled to a motor vibrator 236. The controller may include memory encoded with programmed with instruction to receive inputs and in response to those inputs control motor vibrators 236.

In FIG. 2, pre-programmed protocols maybe encoded to allow for a user to select a protocol using on or more of the input devices. For example, and without limitation, a user selects a protocol by cycling through an input button. The visible output 220 may indicate the selected protocol. The protocol is transmitted via Bluetooth 218 to the device 212 and the main control unit 224 effectuates the protocol on motors 236.

### Application

Electronic control for the sexual gratification device 118 may be built into the gratification device or remote to it. If it is remote, it can be on the same person with the sexual gratification device, or another person may have control. It can be obvious or clandestine (e.g. a wrist device or a pendant on a necklace or just a fob on a shoelace). The control is not a button control but instead it is motion controlled. In operation the person with the control may make specific motions to control the sexual gratification device 118 to perform specific functions, (e.g. turn on and off vibration, increase vibration speed, decrease vibration speed or turn on or off and control any other function for which it is built).

The app 114 may present the user with options to select the inertial sensor 116 and gratification device 118 based on the detection of connected devices. Once selected a user may select the desired protocols for operation of an inertial sensor 116 and the desired result for the gratification device 118. These selections may be menu driven, and once selected, the app 114 transmits those protocols to the inertial sensor 116 and gratification device 118.

The App 114 may be used to pair the control functions and the inertial sensor 116 to operate the sexual gratification device 118. In addition, the gratification device 118, inertial sensor 116 and the App 114 may have bi-directional communications using wireless technology 112. This may allow for feedback information to the App 114 that is then logged on a database so that users can view the device usage reports or share device usage activities on social media or by email.

Historical usage may be used to populate a menu structure for selecting protocols for operations.

In certain embodiments (see below), the inertial sensors 116 may operate directly with the gratification device without the intervention of the App 114. Moreover, certain embodiment may not require an app at all. In those application the remote device may have a button or other input device to control operation.

### Operation

In one embodiment the inertial sensor 116 may be included in a cell phone with an application (“App”) 114 operating on the cell phone's operating system. Once procedures are established using the App 114, the motion of the cell phone from its inertial device 116 will trigger the gratification device to perform the predetermined functions. Those predetermined functions may be selected using the App 114 and transmitted as needed to the gratification device or the gratification device may have predetermined actions downloaded to it.

In yet another embodiment the gratification device and inertial sensor 116 may wirelessly receive command protocols from the App 114. This command protocol may then reside on the gratification device and inertial sensor 116. Thereafter, when the inertial sensor 116 is triggered by a predetermined motion, it wirelessly signals the gratification device to perform its protocol function thus obviating the need of the App 114 or processor 110 to be included in the operation.

In yet another embodiment a wristband or pendant may include an inertial sensor 116. The App 114 establishes a motion protocol for the inertial sensors 116 and the gratification device 118 and communicates the protocol to the devices. When a user moves the wristwatch or pendant in the predetermined protocol, the wristwatch or pendant signals the gratification device 118 to perform its predetermined protocol.

Protocols may include time-cycling of a specific vibrator, sequentially vibrating different vibrators at a pre-determined rate, setting the vibrating intensity, and the like.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings including those in the attached Appendix. The embodiments were chosen and described in order to best explain the principles of the invention and its practical applications, to thereby enable others skilled in the art to best utilize the current disclosure and various embodiments with various modifications as are suited to the particular use contemplated, especially in light of the following claims.

What is claimed:

1. A system including:
a processor, said processor coupled to at least one motor controller, said motor controller further coupled to one or more motorized vibrators;
said processor further coupled to a wireless transceiver;
a remote device, said remote device coupled to the processor through the wireless transceiver, said remote device including one or more motion sensors;
a memory device coupled to said processor, said memory device including non-transient, machine-readable instructions directing the processor to perform a method including:
communicating with the remote device;
receiving an input from the remote device, said input indicative of motion from the remote device, and
operating the one or more motorized vibrators in response to the input.

2. The system of claim 1 wherein the remote device attaches to a wrist.

3. The system of claim 1 wherein the processor and vibrator are enclosed in a flexible waterproof enclosure.

4. The system of claim 1 wherein the input from the remote device includes a protocol for operating the one of more motorized vibrators.

5. A remotely operated vibrating device including:
an first portion, said first portion including a controller, and transceiver, and one or more vibrating motors;
a remote portion wirelessly coupled to the first portion, said remote portion including a transceiver and an accelerometer;
said remote portion operable to detect motion and in response to said motion, transmit commands to the first portion, wherein said first portion is operable to control the one or more vibrating motors in response to the commands.

6. The device of claim 5 wherein the remote device attaches to a wrist.

7. The device of claim 5 wherein the processor and vibrator are enclosed in a flexible waterproof enclosure.

8. The device of claim 5 wherein the commands from the remote portion include a protocol for operating the one of more vibrating motors.

9. The device of claim 8 wherein the protocol is selected from a menu of protocols encoded in the remote portion.
